(19) United States
(12) Patent Application Publication
(10) Pub. No.: US 2018/0221893 A1
(43) Pub. Date: Aug. 9, 2018

(54) ELECTRICAL DISPENSING ASSEMBLY FOR A SHOWER SPRINKLER

(71) Applicant: Xiamen Runner Industrial Corporation, Xiamen (CN)

(72) Inventors: YI-MIN LIN, Xiamen (CN); QING-PING WANG, Xiamen (CN); FU-XIN HUANG, Xiamen (CN)

(21) Appl. No.: 15/836,661

(22) Filed: Dec. 8, 2017

(30) Foreign Application Priority Data
Feb. 9, 2017 (CN) 201720120215.6

(51) Int. Cl. B05B 1/16; B05B 12/00; E03C 1/04

(52) U.S. Cl. CPC B05B 1/16; E03C 1/0408; B05B 12/002

(57) ABSTRACT

An electrical dispensing assembly for a shower sprinkler having a body provided with multiple first outlets includes a dispensing disk having multiple second outlets communicating with the first outlets of the body, a rotation disk rotatably mounted on top of the dispensing disk and having at least two third outlets each alternately communicating with one of the second outlets so as to change water output pattern from the body and a driving device mounted on a side of the rotation disk to drive the rotation disk for a predetermined period of time.

### CROSS REFERENCE

This application claims the priority of Chinese Application No. 201720120215.6, filed on Feb. 9, 2017 and the entirety thereof is herein incorporated with reference.

### TECHNICAL FIELD

The preferred embodiment of the present invention is related to the field of a shower sprinkler and, more particularly, to an electrical dispensing assembly for a shower sprinkler to electrically control water output pattern.

### BACKGROUND OF THE INVENTION

In our daily lives, when the water sprinkler in the bathroom is used for showering, the user rotates the knob beside the sprinkler to active water output from the sprinkler head. Normally, this type of shower head satisfies the basic requirements for taking a shower. As technology advances, people start using the shower head to fulfill different purposes while taking a shower, i.e., massaging. That is, when the user is taking a shower, the user wishes the shower head to accomplish the objective of massaging a particular area, such as skin, shoulder or the lower back. As water pressure is constant during the entire water supply process, changing the size of the water outlet may also change the water jet strength as long as the water supply is continuous. After the water outlet size is change and the water jet strength is changed accordingly, the user may then enjoy the continuous or intermittent impact from water jet. Sometimes, the user may want a soft and gentle water jet to massage the head or sometimes the user may want a strong water jet to remove or ease soreness from exercise in body portions or do the physical therapy to a certain specific area, the user rotates a dispensing plate to reallocate one of the water outlets of the dispensing plate to align with the water outlet of the shower sprinkler, which is troublesome and labor inefficient.

In order to solve the problem, the solution is to provide an electrical dispensing assembly to automatically change the outlet alignment of the dispensing plate and of the shower sprinkler.

### SUMMARY OF THE INVENTION

It is an objective of the preferred embodiment of the present invention to provide an electrical dispensing assembly having therein a motor and a rotation disk driven by the motor and provided with at least two outlets each alternately aligning with water outlets of the shower sprinkler so as to change water output pattern.

In order to accomplish the abovementioned objective, the electrical dispensing assembly constructed in accordance with the preferred embodiment of the present invention includes

### BRIEF DESCRIPTION OF THE DRAWINGS

FIG. 1 is a schematic cross-sectional view showing that the electrical dispensing assembly of the preferred embodiment of the present invention is incorporated in a conventional shower sprinkler;

FIG. 2 is an exploded perspective view showing parts of the electrical dispensing assembly of the preferred embodiment of the present invention;

FIG. 3 is an exploded perspective view showing still parts of the driving device of the preferred embodiment of the present invention;

FIG. 4 is a schematic perspective view showing a limiting device of the preferred embodiment of the present invention; and

FIG. 5 is a schematic circuit diagram showing the circuitry principle used in the design of the switches of the preferred embodiment of the present invention.

### DETAILED DESCRIPTION OF THE PREFERRED EMBODIMENT

Preferred embodiment(s) of the present invention in combination with the attached drawings shall be provided in detail in the following description. However, the given description is for example purpose only and should not be deemed as a limiting to the scope of the present invention in any way.

In order to make it easy to carry out the preferred embodiment of the present invention, a detailed description of the parts of the invention, supported with figures is provided here. As each part of the preferred embodiment of the present invention has many features, it is made easy to read, by referring to each feature with a number included in the parts description text. The number of the parts feature(s) is indicated here by starting it sequentially from the number 1, wherever a part feature appears in a text, an associated serial number is directly assigned.

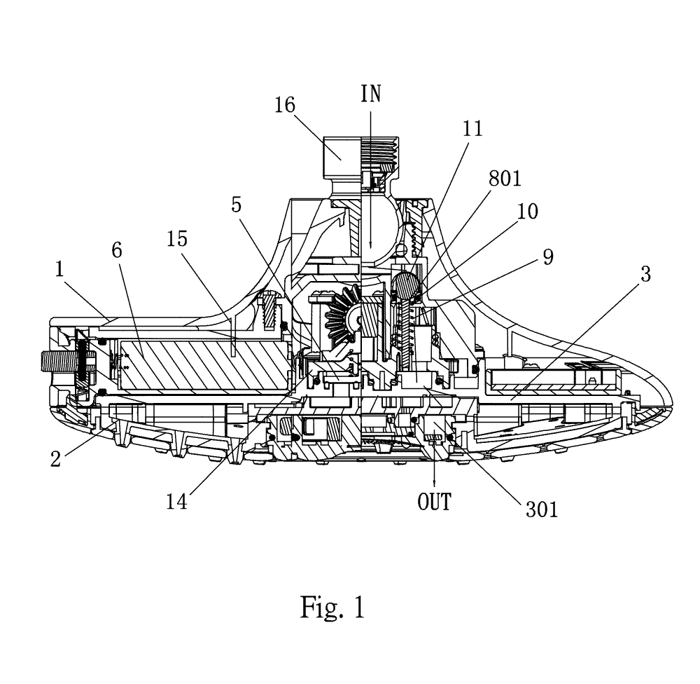

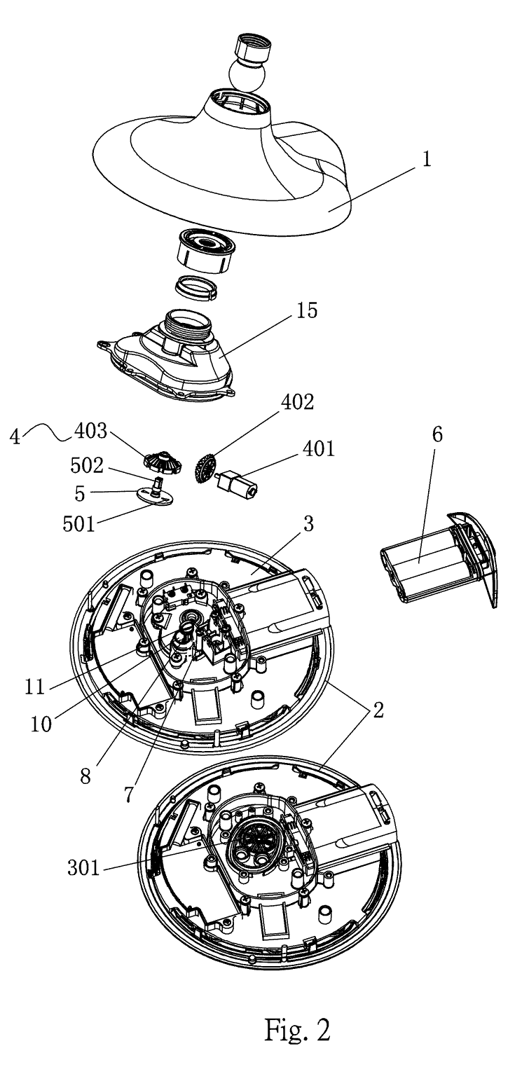

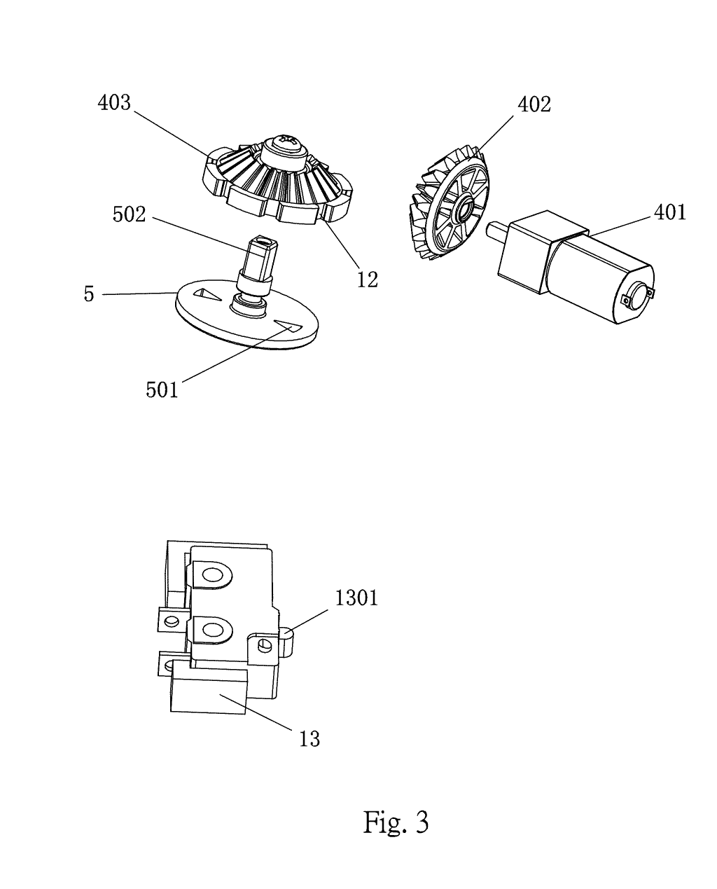

With reference to FIGS. 1, 2, 3 and 4, the electrical dispensing assembly constructed in accordance with the preferred embodiment of the present invention includes a dispensing plate 2 mounted on top of a shower sprinkler body 1 (from viewer's direction) and having multiple first outlets, a dispensing disk 3 mounted on top of the dispensing plate 2 and having at least two second outlets 301 communicating with the first outlets of the dispensing plate 2, a driving device 4, and a rotation disk 5 driven by the driving device 4 and consequently driving the dispensing disk 3.

The driving device 4 includes a motor 401, a first gear 402, preferably a conical gear and a second gear 403, preferably a conical gear, meshed with the first gear 402. The rotation disk 5 includes a pole 502 standing upright from a face of a disk (not numbered) having at least two third outlets 501 each alternately communicating with one of the at least two second outlets 301 of the dispensing disk 3. The pole 502 has a geometric shape, such as square, triangle or the like, corresponding to that of a through hole (not numbered) defined through the second gear 403 so that after the pole 502 extends through the through hole of the second gear 403, the second gear 403 is firmly and securely connected to the rotation disk 5. A battery compartment (not numbered) is provided inside the body 1 to receive therein a battery 6 for providing electricity to the motor 401 via a first switch 7, preferably, a magnetic switch. A plug 8 having thereon a spring 9 and a sensor 11 is provided on top of an inlet 10 of the body 1 to constantly stop waterflow from the inlet 10 to the body 1. Preferably, the sensor 11 is a magnet.

A second switch A is connected to the first switch 7 in series to control operation of the motor 401 as the first switch 7 is maintained closed ever since water comes in from the inlet 10. Activation knob (not numbered) of the second switch A is formed on the surface of the body 1 to allow the user to easily activate the operation of the motor 401 by a gentle touch to the activation knob of the second switch A and thus the motor 401 is activated. Only after the motor 401 is activated, are the first and second gears 402, 403 consequently driven by the motor 401 to rotate for a predetermined phase. That is, after the motor 401 is activated, the motor 401 only drives the first gear 402 and the second gear 403 for a predetermined period of time to drive the rotation disk 5 to rotate and consequently to align one of the at least two third outlets 501 with one of the at least two second outlets 301 of the dispensing disk 3 and change water output pattern.

Preferably, the second switch A maybe a RF switch and the remote control for the second switch A is isolated from the body 1 of the dispensing assembly and, therefore, detailed description thereof is omitted for brevity.

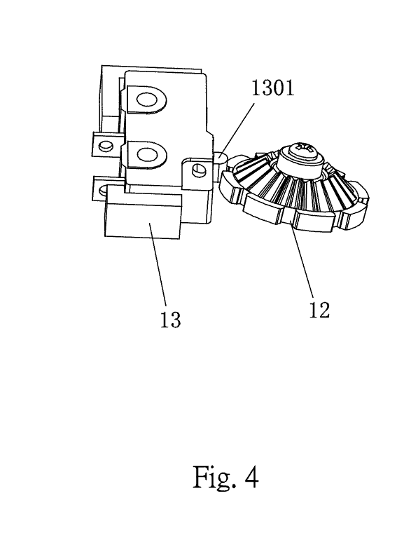

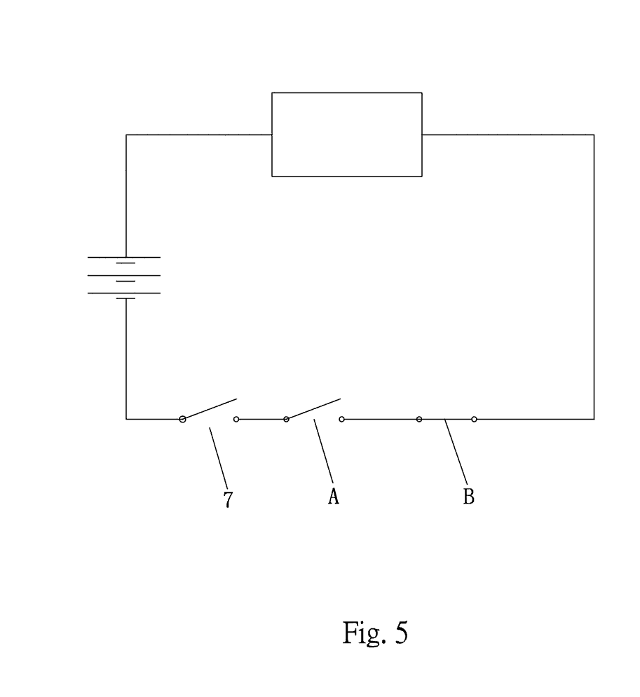

A limiting device 13 includes a contact 1301 retractably mounted on the limiting device 13 and multiple recesses 12 formed on a peripheral edge of the second gear 403 to respectively correspond to and receive therein the contact 1301. From the depiction of FIGS. 4 and 5, it is appreciated that since first switch 7 and the second switch A are constant closed-switch and the limiting device 13 functions as a constant opened-switch B, every time the contact 1301 falls into one of the recesses 12 of the second gear 403, circuit providing electricity to the motor 401 is opened and the motor 401 stops operation.

Furthermore, a fixing cover 14 is mounted on top of the dispensing disk 3 to secure the location of the dispensing disk 3 and a protection cover 15 enclosing therein the dispensing disk 3 and the fixing cover 14 is mounted on top of the fixing cover 14. Activation knob for the second switch A may be provided on top of the protection cover 15 for easy access by the user.

After a detailed description of the preferred embodiment(s) has been provided, any skilled person in the art would easily understand the description so provided is for example purpose only. The scope for protection of the present invention is defined by the attached claims. Any skilled person in the art would easily amend, modify or alter the elements/devices of the present invention without departing from the principle essence and spirit of the present invention. However, the amendment, modification or alteration shall fall within the protection scope sought of the present invention.

What is claimed is:

1. An electrical dispensing assembly for a shower sprinkler having a body provided with multiple first outlets, the electrical dispensing assembly comprising:
a dispensing disk having multiple second outlets adapted to communicate with the first outlets of the body;
a rotation disk rotatably mounted on top of the dispensing disk and having at least two third outlets each alternately communicating with one of the second outlets so as to change water output pattern from the body; and
a driving device mounted on a side of the rotation disk to rotate the rotation disk for a predetermined period of time to allow alignment between one of the at least two third outlets and one of the second outlets during operation of the driving device.

2. The electrical assembly as claimed in claim 1, wherein the driving device has a motor, a first gear driven by the motor and a second gear meshed with the first gear and securely connected to the rotation disk such that the rotation disk is rotated to allow the at least two third outlets to alternately communicating with one of the second outlets and consequently change the water output pattern.

3. The electrical assembly as claimed in claim 1 further comprising a limiting device to limit operation of the motor.

4. The electrical assembly as claimed in claim 3, wherein the limiting device includes a contact retractably mounted thereon and multiple recesses formed on a peripheral edge of the second gear to respectively correspond to and receive therein the contact to intermittently interrupt power supply to the motor.

5. The electrical assembly as claimed in claim 2 further comprising a limiting device to limit operation of the motor.

6. The electrical assembly as claimed in claim 5, wherein the limiting device includes a contact retractably mounted thereon and multiple recesses formed on a peripheral edge of the second gear to respectively correspond to and receive therein the contact to intermittently interrupt power supply to the motor.

7. The electrical assembly as claimed in claim 1 further comprising a fixing cover mounted on top of the dispensing disk to secure location of the dispensing disk.

8. The electrical assembly as claimed in claim 7 further comprising a protection cover mounted on top of the fixing cover to enclose therein the dispensing disk and the fixing cover.

9. The electrical assembly as claimed in claim 5 further comprising a fixing cover mounted on top of the dispensing disk to secure location of the dispensing disk.

10. The electrical assembly as claimed in claim 9 further comprising a protection cover mounted on top of the fixing cover to enclose therein the dispensing disk and the fixing cover.
